(19) United States
(12) Patent Application Publication
(10) Pub. No.: US 2026/0208386 A1
(43) Pub. Date: Jul. 23, 2026

(54) CONTROLLED BREAKING SYSTEM

(71) Applicant: ECZACIBASI MONROL NÜKLEER ÜRÜNLER SANAYI VE TICARET ANONIM SIRKETI, Gebze/Kocaeli (TR)

(72) Inventors: Mustafa ÇAKMAK, Gebze/Kocaeli (TR); Ibrahim AKSOY, Gebze/Kocaeli (TR)

(21) Appl. No.: 19/144,092

(22) PCT Filed: Jul. 18, 2023
(86) PCT No.: PCT/TR2023/050689

§ 371 Date: Jun. 27, 2025

(30) Foreign Application Priority Data
Dec. 30, 2022 (TR) 2022021593

(51) Int. Cl. B26F 3/00

(52) U.S. Cl. CPC B26F 3/002

(57) ABSTRACT

A controlled breaking system enables an ampoule containing a radioactive substances to be broken in a controlled manner at the stages where it is necessary to remove such substances from the ampoule. The breaking system includes at least one first body, at least one shaft, at least one shaft bearing, at least one ampoule holder, at least one second body, at least one jaw and at least one support member.

### SUBJECT OF THE INVENTION

The invention relates to a controlled breaking system, which enables an ampoule serving to preserve the substances hazardous to health and environment, such as the radioactive substances, to be broken in a controlled manner at a stage where it is necessary to remove such substances from said ampoule and which thus enables said ampoule to be separated in a subsequent stage from the substance contained therein, easily and in an highly efficient manner. The invention further relates to the use of said system and to a method for breaking an ampoule using said system.

### STATE OF THE ART

In the recent years, there has been a considerable progress in the development of the novel cancer treatment methods, due to the increasing prevalence of the cancer. The radiotherapy is the most commonly used radiation treatment for the cancer patients. By means of radiotherapy, a high dose of radiation is administered externally to a tumor and a limited area around the tumor. Another treatment method available for some cancer types is the targeted radionuclide therapy performed by the use of the radioactive substances. Every radionuclide used in the cancer treatment is tumor-specific; for example, while radioactive iodine is effective for the treatment of thyroid neoplasms, radioactive lutetium is effective in the treatment of the prostate cancer. Radioactive nuclide treatment is applied locally or systemically to the target tissue for the cancer types such as the liver tumors, prostate tumors, thyroid neoplasms, bone tumors and lymph tumors. During the administration, the radionuclides reach the cancerous cells in the body through the bloodstream and cause the destruction of the cells by emitting radiation to these cells on the molecular level.

However, the radioactive substances may treat the cancer on the one hand and may cause the cancer on the other hand, depending on the area where the radiation emitted by said radioactive substances reaches. In case the emitted radiation finds its way to the healthy tissues in any way, the cells in the healthy tissues are damaged and transform into the cancerous cells in severe cases of exposure. For this reason, it is necessary to preserve the radioactive substances to be used in the treatment of the cancerous cells in such a way that said radioactive substances will be prevented from emitting radiation to the ambience. The radioactive substances are generally preserved in the quartz ampoules, because said quartz ampoules prevent the emission of the radiation, are pressure-resistant, and contain minimum level of impurity. These ampoules, which preserve the radioactive stock solution used as a raw material in the manufacture of the anticancer drugs, are, at some stage, required to be disposed of and removed from the reaction medium.

According to the state of the art, certain systems and methods are employed in order to perform said disposal process in such a way that the ampoules are not touched and the emission of radiation to the ambience is prevented. One of these is the method that involves cutting the ampoules with a sharp and precise apparatus. Although it is a costless and easy-to-implement method, it is not possible to completely separate the ampoule particles from the solution due to said ampoule particles mixing into the stock solution during the cutting action, and thus, the purity of the solution becomes impaired and/or the solution loses its properties. In this case, the losses of raw material, energy and time are encountered. Another commonly preferred method according to the state of the art is the method that involves breaking the ampoules by means of pneumatic systems. However, since the breaking action occurs in this case in an uncontrolled manner by using an unnecessarily high power, the ampoule may break down into particles with a size smaller than the desired. Accordingly, it becomes difficult to separate from the stock solution the ampoule particles, which mix into said stock solution as a result of breaking of the ampoule, the properties of the solution may be impaired and/or some of the solution may be lost during the separation process.

In order to meet the need to break in a size-controlled manner the ampoules, which contain any substance that is dangerous to touch and to spread around, including but not limited to radioactive substances, at the stages where it is necessary to remove said substances from said ampoules while said substances are being processed, a breaking system, which enables said ampoules to be broken in a controlled and mechanical manner, and a method for breaking said ampoules by the use of said system, have been developed within the scope of the invention. Owing to the breaking system according to the invention, the ampoules may be broken down into particles that are of a size possible to be readily and entirely separated from the substance, no losses of substance are encountered during the separation process, the properties of the substance remain unchanged, and no losses of raw material, energy and time are encountered.

### OBJECT OF THE INVENTION

An object of the invention is to develop a controlled breaking system, which enables the ampoules to be broken in a controlled manner at the stages where it is necessary to remove the chemical substances from the ampoules serving to preserve the same.

Another object of the invention is to develop a controlled breaking system, which enables the ampoules to be broken in such a way that the ampoule particles resulting from the breaking process is of a size possible to be entirely separated from the chemical substance and which thus prevents the losses of substance during the separation process, the changes in the properties of the substance, the impairment of the impurity level of the substance, and the losses of raw material, energy and time.

### DESCRIPTION OF THE FIGURES

FIG. 1: A perspective view of a preferred embodiment of the breaking system according to the invention in a state where the jaw is at the initial position

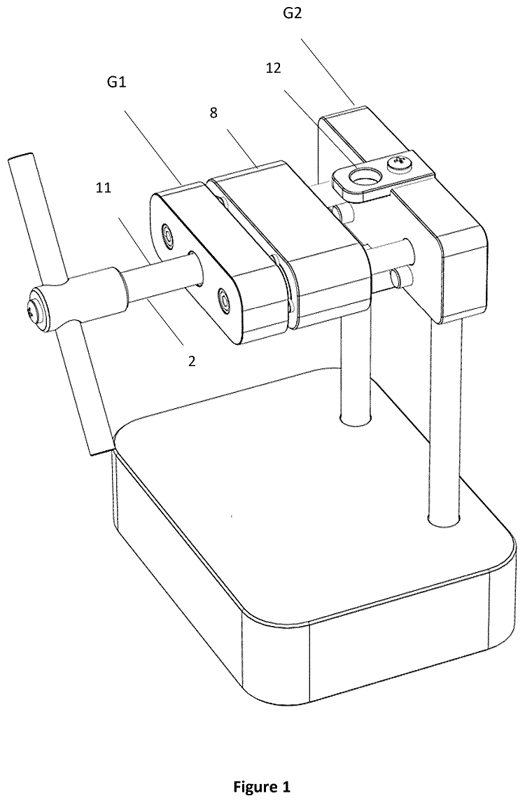

FIG. 2: A perspective view of a preferred embodiment of the breaking system according to the invention in a state where the jaw has been advanced

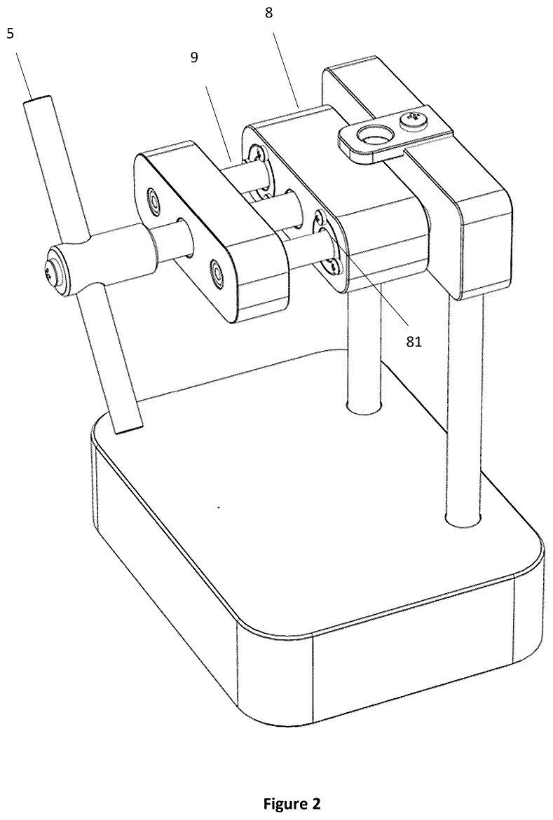

FIG. 3: A perspective view of another preferred embodiment of the breaking system according to the invention in a state where an ampoule has been placed into said breaking system

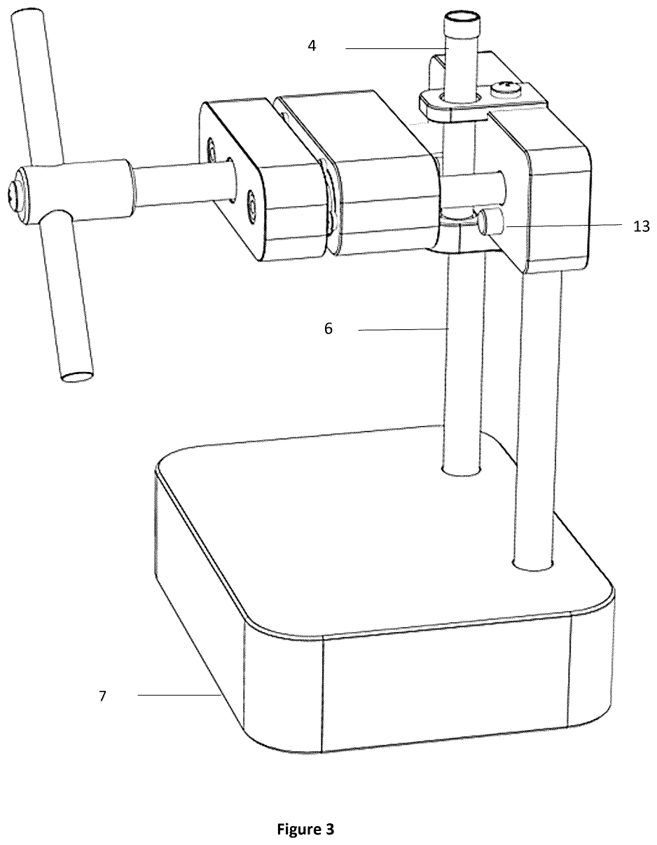

FIG. 4: A side view of another preferred embodiment of the breaking system according to the invention in a state where an ampoule has been placed into said breaking system

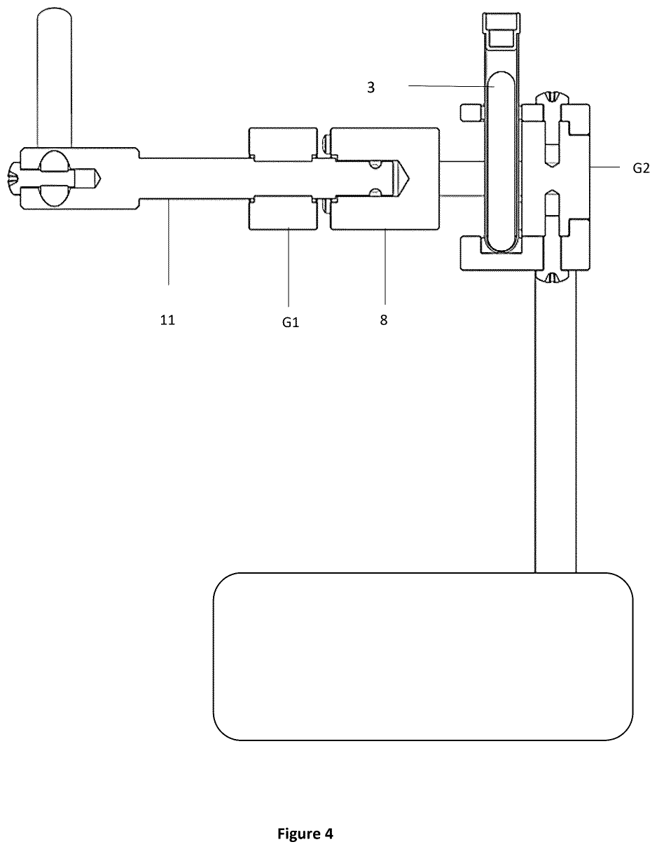

Reference Numerals

| G1 | First body |
|---|---|
| G2 | Second body |
| 11 | Shaft bearing |
| 12 | Ampoule holder |
| 13 | Stopping member |
| 2 | Shaft |
| 3 | Ampoule |
| 4 | Protective container |
| 5 | Control member |
| 6 | Fixing leg |
| 7 | Fixing body |
| 8 | Jaw |
| 81 | Support member bearing |
| 9 | Support member |

### DESCRIPTION OF THE INVENTION

The invention relates to a controlled breaking system, which enables an ampoule serving to preserve the substances hazardous to health and environment, such as the radioactive substances, to be broken in a controlled manner at the stages where it is necessary to remove such substances from said ampoule.

The breaking system according to the invention basically comprises at least one first body (G1); at least one shaft (2), which is placed into the first body (G1) and which moves inside said first body (G1) upon the application of a force; at least one shaft bearing (11) disposed on the first body (G1), into which the shaft (2) is to be positioned and inside which said shaft (2) is to move; at least one ampoule holder (12), into which a brittle ampoule (3) containing a radioactive substance is to be positioned; at least one second body (G2), into which the ampoule holder (12) is to be positioned; at least one jaw (8), which moves towards the ampoule (3) as a result of a force transmitted from the shaft (2), transmits said force to said ampoule (3) and enables said force to act over wider surface; and at least one support member (9), which provides the connection between the first body (G1) and the second body (G2) and on which the jaw (8) is to advance.

The breaking system according to the invention additionally comprises at least one support member bearing (81) on the jaw (8).

The breaking system according to the invention additionally comprises at least one support member bearing (81) on the first body (G1) and at least one support member bearing (81) on the second body (G2).

In a preferred embodiment of the breaking system according to the invention, the ampoule holder (12) and the shaft bearing (11) are perpendicular to each other.

In a preferred embodiment, the breaking system according to the invention comprises a threaded shaft (2) and a shaft bearing (11), which has a form compatible with the threads of the shaft (2).

In a preferred embodiment, the breaking system according to the invention comprises at least two support members (9), on which the jaw (8) is to advance, and at least two support member bearing (81).

In a preferred embodiment, the breaking system according to the invention comprises a control member (5), which is linked to the shaft (2) and which is intended to enable the force to be applied more easily, i.e. to provide the user with the ease of use. The control member (5) may preferably have a structure integrated with the shaft (2) or may be separate part fitted on the shaft (2).

In an embodiment where it is preferred to keep the breaking system according to the invention fixed at a position higher than the surface on which said breaking system is to be positioned, the breaking system comprises a fixing system. In this embodiment of the breaking system according to the invention, the fixing system comprises at least one fixing leg (6) having a length compatible with the height, at which the components of said breaking system other than said fixing system are desired to be located, and at least one fixing body (7), which is intended to enable the components to remain fixed at the desired height, is positioned on the surface and is enabled to be linked to the fixing leg (6). In this case, the fixing body (7) comprises thereon at least one fixing leg (6) housing, into which at least one fixing leg (6) is to be positioned, or, the fixing leg (6) may have a structure integrated with the fixing body (7).

In an embodiment where the breaking system according to the invention comprises a fixing system, the fixing system comprises two fixing legs (6) and a total of two fixing leg (6) housings, i.e. one fixing leg (6) housing for each fixing leg (6), on the fixing body (7).

In the embodiment where the breaking system according to the invention comprises a fixing system, the fixing leg (6), which is enabled to be linked to the fixing body (7), should be enabled to be linked also to the second body (G2) so that said fixing leg (6) may be fixed to the breaking system. In this case, the second body (G2) of the breaking system according to the invention comprises at least one fixing leg (6) housing, into which the fixing leg (6) is to be positioned, or, the fixing leg (6) may have a structure integrated with the second body (G2). The fixing leg (6) is linked on end thereof to the fixing body (7) and on the other end thereof to the second body (G2).

In an embodiment where the breaking system according to the invention comprises a fixing system, the fixing system comprises two fixing legs (6) and a total of two fixing leg (6) housings, i.e. one fixing leg (6) housing for each fixing leg (6), on the second body (G2).

In order to enable more than one ampoule (3) to be broken simultaneously, the breaking system according to the invention may preferably comprise a number of ampoule holders (12) corresponding to the number of ampoules (3) desired to be broken simultaneously.

In order to preserve the radioactive substance in a contactless manner also following the process of breaking performed to break an ampoule (3), inside which a radioactive substance is preserved, by the use of the breaking system according to the invention, said ampoule (3) is preferably placed into a protective container (4). The protective container (4) is preferably manufactured from a flexible material that recovers its original form after the application of the force is terminated.

In a preferred embodiment, the breaking system according to the invention comprises at least one stopping member (13), which is disposed on the second body (G2) and which, by permitting the jaw (8) to advance up to the axis of the ampoule (3), prevents said ampoule (3) from being broken down into particles of a size that is smaller than the desired.

The subject of the invention further relates to a method for breaking in a controlled manner an ampoule (3), serving to preserve the substances hazardous to health and environment, such as the radioactive substances, by the use of a controlled breaking system, which enables said ampoule (3) to be broken in a controlled manner, at the stages where it is necessary to remove such substances from said ampoule (3), said method comprising the steps of
positioning an ampoule (3), inside which a chemical substance is preserved, into the ampoule holder (12) on the second body (G2),
applying a force on the shaft (2), which is placed into the shaft bearing (11) on the first body (G1), in a direction towards the location of the ampoule (3) and thus enabling said shaft (2) to advance inside said shaft bearing (11) in said direction,
the jaw (8), which is linked to the shaft (2) and which enables the applied force to act over a wider surface, advancing in the direction towards the location of the ampoule (3), upon the movement of said shaft (2), and
continuing to apply the force on the shaft (2) until the force that is transmitted to the jaw (8) is transmitted from said jaw (8) to the ampoule (3) and said ampoule (3) is broken.

In a preferred embodiment, the method according to the invention comprises the step of placing the ampoule (3) into a protective container (4), which is manufactured from an elastic material not affected by the applied force, before said ampoule (3) is placed into the ampoule holder (12) on the second body (G2).

In a preferred embodiment, the method according to the invention comprises the step of applying a force on the threaded shaft (2) placed on the first body (G1) and enabling said shaft (2) to move inside the shaft bearing (11) that has a form compatible with the threads of said shaft (2).

The subject of the invention further relates to the use of the system according to the invention for the purpose of breaking in a controlled manner a quartz ampoule (3), in which a radioactive substance is preserved, at a stage where it is necessary to remove said radioactive substance from said quartz ampoule (3).

Owing to the breaking system according to the invention, the ampoule (3) may be broken down into particles that are of a size possible to be readily and entirely separated from the chemical substance that is hazardous to health, no losses of substance are encountered during the separation process performed after the breaking process, the properties of the substance remain unchanged, and no losses of raw material, energy and time are encountered.

1. A controlled breaking system for enabling an ampoule, inside which a radioactive substances is contained, to be broken in a controlled manner, the controlled breaking system comprising
at least one first body,
at least one shaft, which is placed into the first body and which moves inside said first body upon the application of a force,
at least one shaft bearing disposed on the first body, into which the shaft is to be positioned and inside which said shaft is to move,
at least one ampoule holder into which an ampoule containing a radioactive substance is to be positioned,
at least one second body into which the ampoule holder is to be positioned,
at least one jaw, which moves in the direction towards the location of the ampoule as a result of a force transmitted from the shaft and which transmits said force to said ampoule, and
at least one support member on which the jaw is to advance.

2. The controlled breaking system according to claim 1 wherein the shaft is a threaded shaft.

3. The controlled breaking system according to claim 2 wherein the shaft bearing has a form compatible with the thread form on the surface of the shaft.

4. The controlled breaking system according to claim 1 further comprising at least one control member linked to the shaft and which enables the force to be applied on said shaft.

5. The controlled breaking system according to claim 4 wherein the control member has a structure integrated with the shaft.

6. The controlled breaking system according to claim 4 wherein the control member is a separate part fitted on the shaft.

7. The controlled breaking system according to claim 1 further comprising a fixing system, which enables said controlled breaking system to be kept at a position higher than the surface on which said controlled breaking system is to be positioned.

8. The controlled breaking system according to claim 7 wherein the fixing system comprises at least one fixing leg having a length compatible with the height, at which the other components are desired to be located.

9. The controlled breaking system according to claim 7 further comprising at least one fixing body, which is positioned on the surface and is enabled to be linked to the fixing leg.

10. The controlled breaking system according to claim 9 wherein the fixing body comprises at least one fixing leg housing, into which the fixing leg is to be positioned.

11. The controlled breaking system according to claim 9 wherein the fixing leg has a structure integrated with the fixing body.

12. The controlled breaking system according to claim 8 wherein the second body comprises at least one fixing leg housing, into which one end of the fixing leg is to be positioned.

13. The controlled breaking system according to claim 8 wherein the fixing leg has a structure integrated with the second body.

14. The controlled breaking system according to claim 9 wherein the fixing system comprises two fixing legs and the fixing body comprises two fixing leg housings.

15. The controlled breaking system according to claim 8 wherein the fixing system comprises two fixing legs and the second body comprises two fixing leg housings.

16. The controlled breaking system according to claim 1 further comprising a number of ampoule holders corresponding to the number of ampoules, in order to enable more than one ampoule to be broken simultaneously.

17. The controlled breaking system according to claim 1 wherein the ampoule holder and the shaft bearing are perpendicular to each other.

18. The controlled breaking system according to claim 1 further comprising at least one support member bearing on the jaw.

19. The controlled breaking system according to claim 1 further comprising at least one support member bearing on the first body.

20. The controlled breaking system according to claim 1 further comprising at least one support member bearing on the second body.

21. The controlled breaking system according to claim 1 wherein in that the second body comprises at least one stopping member, which prevents the broken ampoule from being broken down into particles of a size that is smaller than desired.

22. A method for breaking in a controlled manner an ampoule, inside which the radioactive substances is contained, by the use of a controlled breaking system developed to break said ampoule in a controlled manner characterized in that the method comprises the steps of
positioning an ampoule into the ampoule holder on the second body,
applying a force on the shaft, which is placed into the shaft bearing on the first body, in a direction towards the location of the ampoule and thus enabling said shaft to advance inside said shaft bearing in said direction,
the jaw, which is linked to the shaft and which enables the applied force to act over a wider surface, advancing in the direction towards the location of the ampoule, upon the movement of said shaft, and
continuing to apply the force on the shaft until the force that is transmitted to the jaw is transmitted from said jaw to the ampoule and said ampoule is broken.

23. The controlled breaking method according to claim 22 further comprising the step of applying a force on a threaded shaft (2) placed on the first body (G1) and enabling said shaft (2) to move inside the shaft bearing (11) that has a form compatible with the threads of said shaft (2).

24. The controlled breaking method according to claim 22 further comprising the step of placing the ampoule into a protective container before said ampoule is placed into the ampoule holder on the second body (G2).
